(19) United States
(12) Patent Application Publication
(10) Pub. No.: US 2006/0235741 A1
(43) Pub. Date: Oct. 19, 2006

(54) Systems and methods for monitoring and reporting

(75) Inventors: Scott Lowrey Deaton, Tucker, GA (US); James David Frost, Savannah, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Dataforensics, LLC

(21) Appl. No.: 11/108,495

(22) Filed: Apr. 18, 2005

(51) Int. Cl. G06F 17/30; G07G 1/00; G06Q 99/00

(52) U.S. Cl. 705/10; 705/1

(57) ABSTRACT

Systems and methods for monitoring and reporting data collected from a remote location are disclosed. A work order, defining a target to be inspected at a remote site and including an inspection plan for collecting target inspection information, is generated on a base-station system and transferred to a portable computing system. Inspection data is collected pursuant to the inspection plan on the portable computing system. Inspection data is transferred from the portable computing system to the base-station system for storage and the generation of related reports.

### TECHNICAL FIELD

The invention relates generally to systems and methods for monitoring and reporting, and more particularly, to systems and methods for the monitoring and reporting of data collected from a remote location.

### BACKGROUND

Conventional remote monitoring and reporting methods, such as groundwater monitoring and reporting, are expensive and labor intensive operations. For example, conventional groundwater site monitoring and reporting methods and systems include providing a well, or other access means for fluid observations, at a predetermined site. Typically, a technician physically visits a site having one or more wells, locates each well to be evaluated at the site, and hand writes information related to the site, well, and the fluid conditions on a paper form.

When the technician visits the field site, the fluid in the well may be sampled for a number of characteristics such as, but not limited to, water quality parameters; groundwater level; and contaminants, including benzene, toluene, chlorinated solvents, ethyl-benzene, aromatic hydrocarbons, and xylenes (BTEX).

For some tests, the fluid sample taken from the well may be transported and analyzed at a laboratory remote from the site. However, inspection information, including test results and/or observations, may be determined on site, visually, or by one or more measurement instruments, and recorded by the technician. However, because the data is manually recorded, recording errors can be introduced. Common recording errors may include transposing digits, incorrectly placing decimals, using incorrect units, or using non-uniform data, etc. Additionally, technicians are not guided through the required test protocols, and thus, may accidentally perform an entirely incorrect set of tests for a given well.

The technician returns from the site and transcribes the information from handwritten notes into a computer located at the base-station site. The information may, for example, be entered directly into a spreadsheet on the computer. In addition to being a time consuming and labor intensive process, there are several opportunities for the introduction of additional recording errors.

U.S. Pat. No. 6,356,205 is directed to a “Monitoring, Diagnostic, and Reporting System and Process.” The system provides for a remote monitoring, diagnostics, and reporting system and method that provides real-time data. The system comprises a well module adapted to be permanently installed in a well, where the module comprises a probe and at least one sensor that senses characteristics of the fluid. The well module is capable of transmitting information concerning fluid characteristics. The system further comprises: a data collection center, which is capable of receiving well information from the well module and generating information concerning characteristics of the fluid; a monitoring site; and a communication link that enables a user at the monitoring site to obtain real-time and historical well information.

However, the systems and methods of U.S. Pat. No. 6,356,205 require costly communications equipment to transmit the information from the well to the data collection center. Additionally, to achieve the remote reporting described in U.S. Pat. No. 6,356,205, each well requires that costly measurement equipment be permanently installed and operated continuously at each well. Furthermore, the system requires a communication link between the module and the data collection center, which may be difficult to provide for sites located in remote areas. Finally, because the process is fully remote, some tests and/or observations which do not have suitable measurement equipment may be difficult, or nearly impossible, to record or administer remotely. For example, there may be government and/or logistical requirements requiring fluid samples to be obtained and delivered to a specific lab for testing. Thus, known remote reporting systems do not address a number of needs.

Therefore, what is needed are alternative systems and methods for monitoring and reporting which are cost-effective, reduce opportunities for recording errors, do not require a remote communications system or monitoring hardware to be installed permanently at each site, and address the need for more accurate and reliable on-site testing, monitoring, and recording.

### SUMMARY

One embodiment of a method for monitoring a groundwater well includes generating a work order at a first location. The work order may identify a groundwater well to be inspected at a site located remote from the first location, and defines an inspection plan for collecting well inspection information. The method further includes assigning the work order to a portable computing system, and transmitting the work order from a base-station system at the first location to the portable computing system at a time when the portable computing system is located at the first location. Well inspection information collected pursuant to the inspection plan is received from the portable computing system at a time when the portable computing system is located at the first location. The collected well inspection information may be collected in a database accessible by the base-station system. Further, additional well inspection information may be imported from a secondary information source into the database. The method may further include generating a report, a portion of the report derived from at least one of the collected well inspection information or the additional well inspection information stored in the database.

Another embodiment may be described as a method for monitoring a target at a remote site. The method includes generating a work order at a first location, the work order identifying a target to be inspected at a site located remote from the first location, and defining an inspection plan for collecting target inspection information. The work order may be assigned to a portable computing system and transmitted from a base-station system at the first location to the portable computing system.

Yet another embodiment may be described as a method for monitoring a target at a remote site. The method includes receiving a work order on a portable computing system, the work order identifying a target to be inspected at a remote site and defining an inspection plan for collecting target inspection information. The method further comprises collecting target inspection information at the remote site with the portable computing system pursuant to the inspection plan, and transmitting the collected target inspection information from the portable computing system to a base-station system.

Another embodiment may be described as being directed to a computer-readable medium having a computer program stored thereon, the computer-readable medium comprising logic. The logic may be configured to generate a work order at a first location, the work order identifying a target to be inspected at a site located remote from the first location, and defining an inspection plan for collecting target inspection information. The logic may be further configured to assign the work order to a portable computing system, and transmit the work order from a base-station system at the first location to the portable computing system.

Another embodiment may be described as being directed to a computer-readable medium having a computer program stored thereon, the computer-readable medium comprising logic. The logic may be configured to receive a work order on a portable computing system, the work order identifying a target to be inspected at a remote site, and defining an inspection plan for collecting target inspection information. The logic may further be configured to collect target inspection information at the remote site with the portable computing system pursuant to the inspection plan. The logic may further be configured to transmit the collected target inspection information from the portable computing system to a base-station system.

Other systems, methods, features and/or advantages will be, or may become, apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 depicts a block diagram of an embodiment of an exemplary monitoring and reporting system.

FIG. 2 depicts a block diagram of an embodiment of the field reconnaissance system of FIG. 1.

FIG. 3 depicts a block diagram of an embodiment of the portable computing system of FIG. 2.

FIG. 4 depicts a block diagram of an embodiment of the base-station system of FIG. 1.

FIG. 5 depicts a block diagram of an exemplary hierarchy of a system for implementing the monitoring and reporting system embodiment of FIG. 1.

FIG. 6 depicts an embodiment of a top-level interface that may be displayed within a graphical user interface of the base-station system of FIG. 4.

FIG. 7 depicts an embodiment of an interface for managing sites that may be displayed within a graphical user interface of the base-station system of FIG. 4.

FIG. 8 depicts an embodiment of an interface for selecting sites that may be displayed within a graphical user interface of the base-station system of FIG. 4.

FIG. 9 depicts an embodiment of an interface for managing the targets (e.g. wells) that may be displayed within a graphical user interface of the base-station system of FIG. 4.

FIG. 10 depicts an embodiment of an interface for managing predetermined target information (e.g. well information) that may be displayed within a graphical user interface of the base-station system of FIG. 4.

FIG. 11 depicts an embodiment of an interface for managing and assigning work orders that may be displayed within a graphical user interface of the base-station system of FIG. 4.

FIG. 12 depicts an embodiment of an interface for browsing sites associated with assigned orders that may be displayed within a graphical user interface of the portable computing system of FIG. 3.

FIG. 13 depicts an embodiment of an interface for entering general information associated with a site that may be displayed within a graphical user interface of the portable computing system of FIG. 3.

FIG. 14 depicts an embodiment of an interface for browsing targets (e.g. wells) associated with a particular site that may be displayed within a graphical user interface of the portable computing system of FIG. 3.

FIG. 15 depicts an embodiment of an interface for entering target readings (e.g. well readings) that may be displayed within a graphical user interface of the portable computing system of FIG. 3.

FIG. 16 depicts an embodiment of an interface for entering target conditions (e.g. well conditions) that may be displayed within a graphical user interface of the portable computing system of FIG. 3.

FIG. 17 depicts a flow diagram depicting the steps of an exemplary method for groundwater monitoring and reporting using an embodiment of the described monitoring and reporting systems.

### DETAILED DESCRIPTION

Systems and methods for monitoring and reporting data from remote sites are disclosed. In one embodiment, the systems and methods for monitoring and reporting are specifically used for the monitoring and reporting of data related to the periodic inspection of groundwater wells located remote from a data collection center.

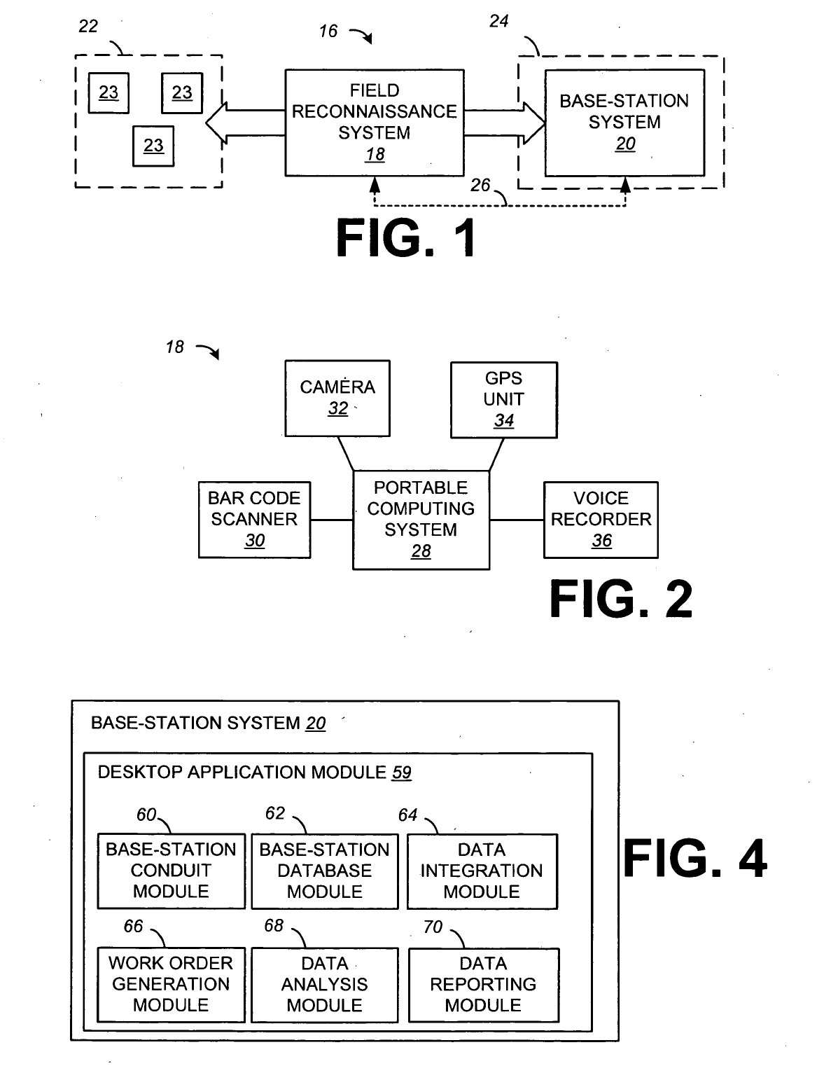

FIG. 1 depicts a block diagram illustrating an exemplary embodiment of a monitoring and reporting system 16. Although monitoring and reporting system 16 may be described herein as a “groundwater” monitoring and reporting system, the inventive systems and methods are not limited to the monitoring and/or reporting of groundwater wells. Rather, embodiments of the systems and methods could be used to monitor and report data representative of information related to other targets located at remote sites. For example, the target may include, but is not limited to, a geological area being monitored for earthquake tremors; soil samples obtained during geotechnical site investigation such as those taken for geotechnical borehole logging; any infrastructure requiring the periodic collection of data for performance monitoring purposes; a construction site requiring the periodic collection of data for quality assurance/quality control purposes; any infrastructure requiring collection of data for condition assessment purposes; and any location requiring collection of information for purposes of evaluating consequences of natural or manmade induced disasters.

Monitoring and reporting system 16 may comprise a field reconnaissance system 18 and base-station system 20. In one embodiment, field reconnaissance system 18 represents a collection of portable devices (see FIG. 2) used to collect on-site information related to site 22, including information related to a number of targets 23 located at site 22. Targets 23 may be, for example, wells containing groundwater. “Monitoring” includes, for example, performing periodic inspections and recording the associated results from the inspections. The inspections may include tests or observations related to a particular site 22, in general, or the specific target 23 located at the site. The portability of field reconnaissance system 18 enables the system, or portions of the system, to be physically transported between data collection center 24 and site 22.

Base-station system 20 may be located remotely from site 22, for example, in data collection center 24. Base-station system 20 may comprise a computing system configured to synchronize information with field reconnaissance system 18 (e.g. transmit information to, and receive data from field reconnaissance system 18). For example, the synchronization may occur over communications interface 26. Communication interface 26 may include any number of wired or wireless interfaces such as, but not limited to, a serial or parallel data interface, a universal serial bus (USB) interface, IEEE 1394 (Firewire), cellular, or Bluetooth.

Base-station system 20 may be further configured to store the received data that represents the collected information, analyze the data, and may further provide a variety of methods for representing the data (e.g. raw data, sorted data, bar charts, spreadsheets, timeline charts, etc.). Base-station system 20 may also be configured to transmit information, such as work orders, to field reconnaissance system 18.

FIG. 2 depicts an embodiment of the field reconnaissance system 18 of FIG. 1. Field reconnaissance system 18 may include a portable computing system 28, which for example, could be a laptop computer or an electronic personal digital assistant (PDA), such as any number of Palm Pilot handhelds manufactured by palmOne, Inc. of Milpitas, Calif. Portable computing system 28 may be configured to synchronize specified data with base-station system 20. For example, target inspection information collected on-site maybe transmitted to base-station 20, and work orders may be received from base-station system 20.

Before describing portable computing system 28 in more detail, other exemplary components that may be included in field reconnaissance system 18 are described. For example, field reconnaissance system 18 may also include a number of accessories used to assist in the collection of information from the targets 23 at the site 22. The accessories, may include, but are not limited to, a bar code scanner 30, a camera 32, a global positioning system (GPS) 34, and a digital voice recorder 36. Each site may also include a number of specialized accessories that remain on-site and are also configured to download information representing collected data directly to portable computing system 28.

To reduce costs, it may be preferable to use portable accessories which may be used across a number of targets 23 and/or sites 22. However, in some instances, the accessories may be left on-site continuously. For example, it may be beneficial to configure a pH recording instrument to periodically or continuously record the pH of groundwater using equipment designed to reside permanently (or semi-permanently) at the monitoring site. The collected pH readings may then be transferred from the pH recording instrument to the portable computing system 28 upon a visit to the site. Because the data collected is not manually transcribed, it becomes more practical to record a large number of measurement readings.

Accordingly, accessories may interface to portable computing system 28 through a wired or wireless connection (e.g. serial, parallel, USB, firewire, bluetooth, PCM-CIA, etc.), and portable computing system 28 is configured to collect a variety of recorded data from each of the accessories. Although several accessories are depicted as being externally attached to portable computing system 28, it should be understood that any portable accessories may be integrated within portable computing system 28 as well.

Bar code scanner 30 may be used to read a bar code label representing static information about the site. For example, the bar code may identify the target (e.g. well and/or site). By collecting the identification data of the target from the bar code and comparing the identification to that supplied in a work order, the risk of accidentally recording data for the wrong target is virtually eliminated. Furthermore, naming conventions are standardized, increasing the chance that the collected data will be properly associated with data previously saved and recorded for a given site and/or well. For example, in the case that a well's identifier is “MW-1,” the technician may be prevented from entering “MW1.”

Camera 32, which may be a digital camera, may be used to take a picture of relevant data. For example, the system may be used to document damage at the well location, and the camera may be used to take a picture of that damage.

GPS 34 may be used to document the precise location of the site being monitored. Although groundwater wells remain stationary, the system could be used, for example, to monitor the health of a living animal which has been tagged with a radio emitting device. Therefore, the GPS is useful to document the location of the animal when the readings are taken. Furthermore, the GPS could be used to assist the technician to locate a target, and also to verify that the technician is actually at the correct target's location (e.g. by cross referencing the position with a known target position).

Voice recorder 36, which may be a digital voice recorder, may be used, for example, to record voice notations associated with the monitoring of a particular target or site.

In addition to the listed accessories 30-36, portable computing system 28 may be configured to interface with any number of other accessories, depending on the type of monitoring being performed.

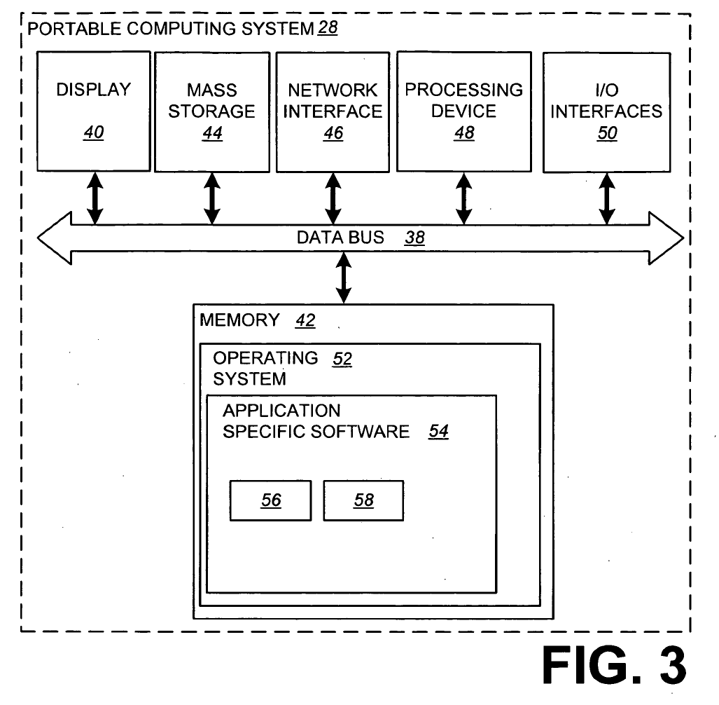

Now looking at portable computing system 28 in more detail, FIG. 3 depicts a block diagram of portable computer system 28 which may be programmed, or otherwise configured, to implement a portion of the described monitoring and reporting system. Computer system 28 has been described as portable, generally meaning that portable computer system 28 can be transported between any number of sites 22 and/or targets 23, and data collection center 24.

However, generally speaking, portable computer system 28 may comprise any one of a wide variety of wired and/or wireless computing devices, such as a laptop computer, PDA, handheld or pen based computer, desktop computer, dedicated server computer, multiprocessor computing device cellular telephone, embedded appliance and so forth. Irrespective of its specific arrangement, portable computer system 28 can, for instance, comprise a bus 38 which may connect a display 40, memory 42, mass storage device 44, network interface 46, processing-device 48, and input/output interfaces 50.

Processing device 48 can include any custom made or commercially available processor, a central processing unit (CPU) or an auxiliary processor, among several processors associated with the computer system 28, a semiconductor based microprocessor (in the form of a microchip), a macroprocessor, one or more application specific integrated circuits (ASICs), a plurality of suitably configured digital logic gates, and other well known electrical configurations comprising discrete elements both individually, and in various combinations, to coordinate the overall operation of the computing system.

Input/output interfaces 50 provide any number of interfaces for the input and output of data. For example, where the portable computer system 28 comprises a personal computer, these components may interface with a user input device (not shown), which may be a keyboard or a mouse. Where the portable computer system 28 comprises a handheld device (e.g., PDA, mobile telephone), these components may interface with function keys or buttons, a touch sensitive screen, a stylus, etc. Display 40 can comprise a computer monitor or a plasma screen for a PC or a liquid crystal display (LCD) on a hand held device, for example.

Memory 42 can include any one of a combination of volatile memory elements (e.g., random-access memory (RAM, such as DRAM, and SRAM, etc.)) and nonvolatile memory elements (e.g., ROM, hard drive, tape, CDROM, etc.). Memory 42 typically comprises a native operating system 52, one or more native applications, emulation systems, or emulated applications for any of a variety of operating systems and/or emulated hardware platforms, emulated operating systems, etc.

For example, the applications may include application specific software 54, which may include a number of executable modules therein. For example, some embodiments may include a field data collection module 56 for collecting field data and a conduit module 58 for transferring data between portable computing system 28 and base-station system 20. Further, memory 42 may further include a number of other executable modules which, for example, could be sub-modules of field data collection module 56 and portable conduit module 58. One of ordinary skill in the art will appreciate that memory 42 can, and typically will, comprise other components which have been omitted for purposes of brevity.

Field data collection module 56, for example, provides the user with a tool for rapidly documenting target inspection information collected pursuant to an inspection plan in a downloaded work order. Target inspection information may include the weather conditions at the site, the target conditions, physical observations of the target, identification of samples removed from the target, the target tests performed, the results of the target tests, for example. Specifically, in the context of groundwater well monitoring, target inspection information may include, for example, liquid level data, well conditions, and field sampling information.

Dialog boxes may be displayed within a graphical user interface (GUI) on display 40 and may generally follow the flow of an inspection plan contained within a work order. In many cases, data input may be automated and synchronized with measurement equipment (e.g. accessories such as the camera, GPS, etc.) through input/output interface 50. For manual input, a keyboard, mouse, or touch sensitive screen may be used, for example. For manual input, drop-down boxes and check boxes may be used to ensure consistent data entries. Interfaces using freeform text boxes may also be used for the entry of information that requires more flexibility.

Portable conduit module 58 is configured to communicate with a corresponding executable module on base-station system 20 (e.g. FIG. 4, desktop conduit module 60). Upon an indication to synchronize information with the base-station system 20, the conduit module is configured to transfer the information between base-station system 20 and portable computing system 28 via a wired or wireless connection during synchronization. For example, the indication may be signaled by docking/connecting (physically or logically) the portable computing system 28 to base-station 20 or by pressing a synchronization button or key-sequence. During synchronization, personal computing system 28 may transfer collected data to base-station system 20, and base-station 20 may transfer a number of work orders to portable computing system 28.

With further reference to FIG. 3, network interface device 46 comprises various components used to transmit and/or receive data over a wired or wireless network (e.g. a local area network (LAN), wide area network (WAN), piconet, or the Internet). By way of example, the network interface device 46 may include a device that can communicate with both inputs and outputs, for instance, a modulator/demodulator (e.g., a modem), wireless (e.g., radio frequency (RF)) transceiver, a telephonic interface, a bridge, a router, network card, etc.) The network interface may also be used to transfer information between the base-station 20 and portable computing system 28 (e.g. during synchronization).

Although portions of the systems and methods of monitoring and reporting system 16 are described as being contained within an executable module, it should be understood that it is not necessary for all described functions to be actually contained within a single executable module. Rather, the functions of “an” executable module may actually be spread across several modules, which may, for example, be sub-modules of each other.

The executable modules may be embodied within a software program, and in the context of this document, a “computer-readable medium” can be essentially anything that can store, communicate, propagate, or transport the program for use by, or in connection with, the instruction execution system, apparatus, or device. The computer-readable medium can be, for example, but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via optical scanning of the paper or other medium, then compiled, interpreted or otherwise processed in a suitable manner if necessary, and then stored in a computer memory.

Looking now to FIG. 4, base-station system 20 is described in more detail. Specifically, base-station system 20 may also comprise a computer system similar to that used by portable computing system 28, described above and referenced in FIG. 3. Accordingly, the details of the system are not repeated. However, it should be understood that base-station system 20 includes similar components, such as, but not limited to a data bus, a display, mass storage, network interface device, a processing device, memory, and input/output interfaces. Similarly, the memory of base-station system 20 may include an operating system residing therein. Further the memory may include application specific software, which contains a number of executable modules.

FIG. 4 depicts a block diagram of a number of executable modules which may be executed by base-station system 20, including: desktop application module 59, base-station conduit module 60, base-station database module 62, data integration module 64, workorder generation module 66, data analysis module 68, and data reporting module 70. Although each of the modules are depicted as separate modules, it should be understood that some embodiments of the system may split or combine the functions of each module into more or less modules.

Desktop application module 59 may, among other functions, include the functionality of each of modules 60-70. In practice, a user of base-station system 20 typically generates and assigns a work order to be completed by a technician. For the case of groundwater monitoring, the user may be a consultant working at the request of an oil company, etc. Accordingly, work order generation module 66 is configured to generate work orders for a particular target 23. In general, the module may be configured to display a number of interfaces that define which tests are to be performed at a particular target by a particular technician. The resulting work orders may be assigned to a portable computing system 28 (which may also correspond to a particular technician) and are transferred to the assigned portable computing system 28 upon synchronization.

A work order may generally include an inspection plan for a technician to perform on-site at an identified target. The inspection plan defines the inspection to be performed for the identified target, and may be viewed as a set of “instructions” for completing the inspection tasks. For example, the inspection plan may provide the framework for resulting displayed interfaces which request the technician to provide target inspection information in a predetermined format and order.

The work order may also contain the following non-exhaustive list of information which may be helpful or required to carry out the inspection in the context of groundwater monitoring: a site and/or target identifier, address, city, state, and/or other identifying and locating information; the wells at the site that should be gauged (e.g. measuring groundwater depth and hydrocarbon depth if present using a probe lowered down the well); the wells that should be purged (e.g. in some cases, a volume of water is pumped out of the well prior to sampling); the types of measurements to perform during purging (i.e. pH, temperature, conductivity, redox, dissolved oxygen, and turbidity can be measured as the water is pumped out of the monitoring well using various available test instruments); the order in which the wells should be gauged, purged and sampled; the types of samples to obtain after purging each; and the types of quality control samples to be obtained by the technician.

In one embodiment, the inspection plan of the work order is performed by following a series of interactive interfaces displayed by desktop application module 59 within a graphical user interface of the portable computing system. The interactive interfaces may include, but are not limited to, data collection fields such as drop down boxes, toggle boxes, check boxes, and freeform text fields for inserting inspection results associated with the inspection plan.

A number of field technicians may synchronize their respective portable computing system 28 with base-station system 20. This synchronization downloads the work orders, if any, assigned to the particular portable computing system. The synchronization may further transfer collected target information, if any, to base-station system 20.

Accordingly, base-station conduit module 60 interfaces with portable conduit module 58 and is configured to transfer information between base-station 20 and portable computing system 28. Upon detecting an indication to synchronize information with the portable computing system 28, base-station conduit module 60 and portable conduit module 58 coordinate to transfer information to and from the portable computing system and base-station system 20.

In general, base-station database module 62 may be configured to interface with any other executable modules as needed, for the purpose of storing and retrieving related data. For example, base-station database module 62 may store and retrieve information related to targets, sites, technicians, and work orders. The information may, for example, include the collected target inspection information or target and/or site information generally known before inspection (e.g. an address, location, identification, the targets associated with the site, physical target dimensions, etc.).

Data on portable computing system 28 and base-station 20 may be stored in any number of ways, including flat files, tables, or, relational databases. However, one embodiment of monitoring and reporting system 16 includes a relational database on both the portable computing system 28 and the base-station system 20 for storing the related data. For example, the data may be stored in a SQL Server relational database, and the database can be accessed via any of the executable modules. The database on base-station 20 may serve as a central repository, which can be used to archive and retrieve all relevant monitoring and reporting data.

In one embodiment, each entity (e.g. site, well, sample, purging measurement, etc.) has its own table in the database, and individual records are stored within each respective table for the entity. Each well belongs to a specific site, thus a relationship exists between these entities and this relationship is maintained by the relational database. In the described embodiment, if a site record is deleted, then it follows that all records associated with the deleted site may also be deleted (e.g. well information for that site, etc.). On the other hand, if a site record is updated, then all records associated with the site may be updated.

The technician executes field data collection module 56 on portable computing system which assists the technician in carrying out the downloaded work orders. For example, field data collection module 56 may display a list of sites associated with the downloaded work orders. The technician proceeds to the specified sites and uses the work order transferred to the portable computing system 28 to determine the tasks to be performed at the specific site (e.g. gauge, purge and sample the wells). The work order may also determine the order of the tests to be carried out. Relevant data during the visit to the site is recorded within portable computing system 28. Error checks may be performed to ensure data is of the highest quality.

When carrying out an inspection plan, a technician may be required to obtain a number of designated samples from the target. In the context of groundwater monitoring, the samples may be containers of water from a groundwater well. The samples obtained may be shipped off to an independent laboratory that tests for contaminants that result from hydrocarbon leaks, for example.

The inspection plan may include the collection of quality control samples used for verification that the technician has performed the inspection properly. For example, the technician may be required to decontaminate the equipment used, and then collect a “rinse” sample. The rinse sample is distilled water that is rinsed on the equipment after it is has been decontaminated. The rinse samples are also used to ensure that the samples are not contaminated during shipping using a “trip blank” sample, which is a reference sample of plain distilled water. Lastly, a “duplicate” sample may be collected to ensure that the laboratory results are accurate. That is, the duplicate sample is a second sample from one of the wells, and the testing results should be similar to those for the original sample.

Upon completion of field work, the technician returns to data collection center 24 and synchronizes the portable computing system 28 with base-station system 20. This synchronization process, which may be carried out by portable conduit module 58 and base-station conduit module 60, transfers the data collected on-site into a database maintained within base-station system 20 (e.g. by interfacing with base-station database module 62).

Data analysis module 68 may be configured to analyze target data (e.g. data recorded at the site related to a particular well), along with any historical recorded data. Data analysis module may, for example, be configured to determine if predetermined set points have been exceeded, analyze trends in data, identify new contaminants in groundwater, anomalies of depth measurements, anomalies of analyzed concentrations, and the email generation for anomaly or contaminant exceedance, etc. For example, in the context of groundwater monitoring, if hydrocarbon product was found in any wells, base-station system 20 may be configured to send a notification email to a project manager. The notification email may, for example, list the site name and any wells where a hydrocarbon product was encountered.

Data reporting module 70 may be configured to use the collected data recorded and historical recorded data to generate reports. For example, the module may provide a variety of methods for representing the data (e.g. raw data, sorted data, bar charts, spreadsheets, timeline charts, etc.).

A field report, detailing the data and samples collected by a technician may be generated by data reporting module 70. A chain of custody document may also be generated by data reporting module 70. If desired, the technician may then print and sign the field report and/or chain of custody.

The collected samples may then be sent, along with the chain of custody document, to an independent testing laboratory where the tests specified on the chain of custody are performed on the samples to determine whether any detectable contaminants are present in the groundwater samples and the quality control samples.

When testing is complete, the laboratory provides additional target inspection information including the laboratory test results for each sample. For example, the laboratory may provide the additional inspection information in an electronic file having the information in a comma separated value (CSV) format, or other format which may be parsed by base-station system 20. For example, data integration module 64 may handle the importing of additional target inspection information, and may interact with database module 62 to store the information in the database.

Once target inspection information has been stored within base-station system 20, a number of reports may be generated by data reporting module 70. For example, a liquid level report may display the gauging data for all historical measurements. An analytical report may show the results of the tests from the lab. A hydrograph may show the groundwater elevation versus a contaminant concentration level over time. Data reporting module 70 may also produce a site map drawing (e.g., from AutoCad) that has either liquid level (gauging data) or analytical data plotted next to each well. Each of these reports may then be included in a comprehensive document that may be provided to a state regulatory agency and the client (e g. in the context of groundwater monitoring, the client may be an oil company).

From a systems standpoint, the executable modules on the portable computing system 28 cooperate with the executable modules on the base-station system 20 to form the complete monitoring and reporting system. FIG. 5 illustrates the hierarchy of this monitoring and reporting system.

Looking to the columns at the top of FIG. 5, the boxes in the right column (labeled BASE-STATION SYSTEM INPUT) indicate configuration that occurs on the base-station system 20. The boxes in the left column (labeled PORTABLE COMPUTING SYSTEM INPUT) indicate target inspection data recorded on the portable computing system 28 based on an assigned work order. Three rows, labeled LEVEL 1, LEVEL 2, and LEVEL 3, relate to the types of information collected or configured.

LEVEL 1 of the system hierarchy generally relates to information about the site 23 being monitored. Site information 72 is configured on the base-station system 20 and is used to generate work orders that are downloaded to the portable computing system 28. Site information 72 may, for example, include the site identification, address, state reporting agency, and the specific gravity of hydrocarbon products that may be encountered in groundwater wells.

Once at the site, responding to a work order, the technician may enter (e.g. manually, through bar codes readers, or accessories) site conditions 74, which may be general information that may apply to every target at the site. For example, site conditions may include the weather and temperature conditions, as well as the technician id. Upon synchronization, this information may be transferred into one or more tables within the database on the base-station system 20.

LEVEL 2 of the hierarchy relates to information about each target 23 being monitored at the particular site. For example, well information 76 is configured on the base-station system 20 and may be used in the generation of work orders that are downloaded to the portable computing system 28. Well information 76 may, for example, include the top of casing, the screen interval, the bottom depth, and the well diameter for each well. This data may be stored in a well information table within the database and is generally not modified except for rare events, such as when a site or target is periodically surveyed. Upon synchronization, active wells and the associated diameter and bottom depth in the sites assigned to the technician are downloaded to the portable computing system within the context of the work order.

On site, the technician records target inspection information which may include readings associated with the target 23. For example, well readings 78 may include liquid level measurements observed by the technician. Upon synchronization with the base-station computer 20, the data represented by the well readings 78 information may be stored in one or more tables on base-station computer 20.

LEVEL 3 of the hierarchy relates to the inspection performed at each target 23 (e.g. which is defined at LEVEL 2). The types of measurements to be performed for each target 23 may be configured in the base-station computer 20 and included within the work order transferred to the portable computing system 28.

For embodiments comprising a groundwater monitoring and reporting system, the types of measurements may include the purging information 80, which specifies the types of purges to be performed for each target 23 (e.g. pH, temperature, conductivity, redox, DO, and turbidity); and the sampling information 82, which specifies the types of samples to be taken for each target 23. In the context of groundwater monitoring, the purging information 80 and sampling information 82 is associated with each well at the remote site. Thus, each well is associated with well information 76 at LEVEL 2. Further, each well information 76 has sampling and purging information associated therewith at LEVEL 3.

While in the field, for each target to be inspected, technicians record the appropriate information. Accordingly, in the context of ground water monitoring, for each well reading 78, technicians record the appropriate data for the purging measurements 84 and sample information 86 on portable computing system 28. Purging measurements 84 store information relating to each of the purges performed. Likewise, sample information 86, for example, may hold information relating to the samples. For example, the date and time each sample is obtained may be stored in sample information 86.

Upon synchronization with base-station system 20, the purging measurement 84 and sample information 86 are transferred to the database in base-station computer 20.

Now that the functional blocks and the hierarchy of the system have been described, a walkthrough of the system is provided, including exemplary user interfaces which may be used to collect and/or display collected information. In summary, the interfaces displayed by the executable modules on the portable computing system 28 may aid in the accuracy and efficiency of data entry in the field. Similarly, the executable modules on base-station system 20 provide an interactive system for generating work orders, compiling target inspection information, providing data analysis, and generating reports related to the collected information. The combination of these interfaces provide easy access to information regarding the status and results of well measurements.

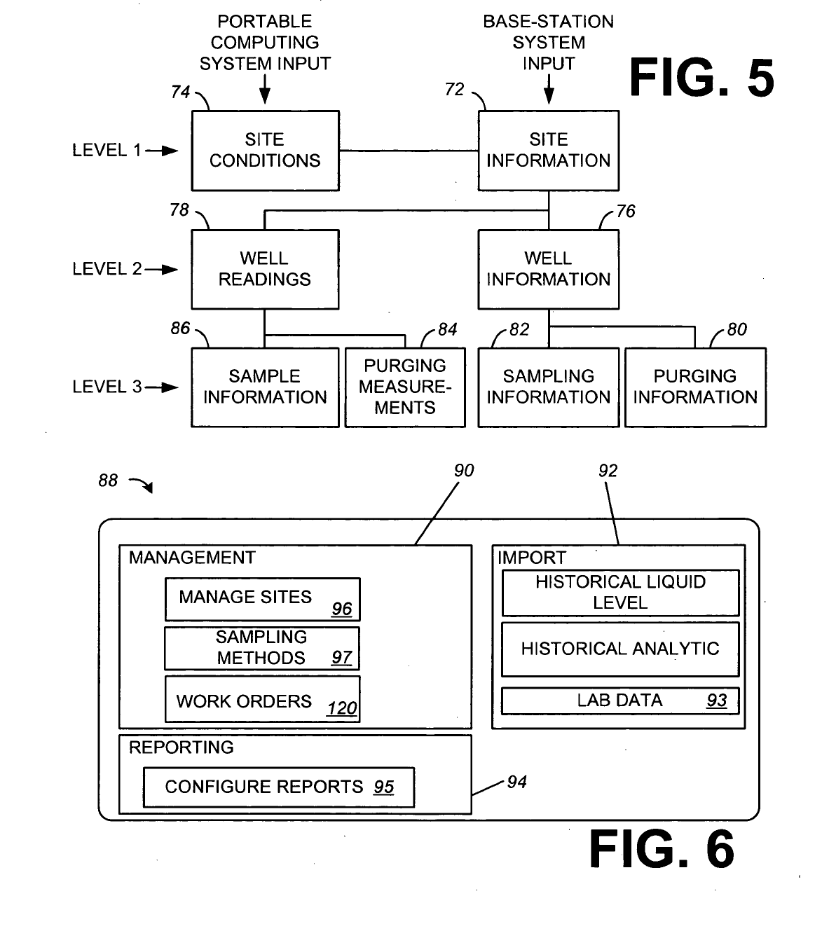

FIG. 6 depicts a top-level interface 88 of the desktop application module 59 executed on base-station system 20 and displayed within a graphical user interface on a suitable display. The interface is generally divided into three major areas providing unique functions: management area 90, import area 92, and reporting area 94. Any of the functions of the desktop application module 59 may be restricted based on a particular user's authentication.

Management area 90 may include a manage sites button 96, sampling methods button 97, and work order button 120 for invoking interfaces for managing sites, work orders, and sampling methods, respectively. For example, information related to the sites, work orders, and sampling methods may be added, deleted, or amended through these interfaces.

Import area 92 may include buttons for importing information into base-station system 20. For example, import area 92 provides interfaces for importing historical target inspection data including liquid levels or other analytic data. Additionally, lab data button 93 may be used to invoke an interface (not shown) used to import laboratory data related to samples which have been provided in an electronic format.

Reporting area 94 may include buttons for configuring and generating reports. For example, configure reports button 95 may invoke an interface for adding, deleting, editing, generating, displaying, and printing reports.

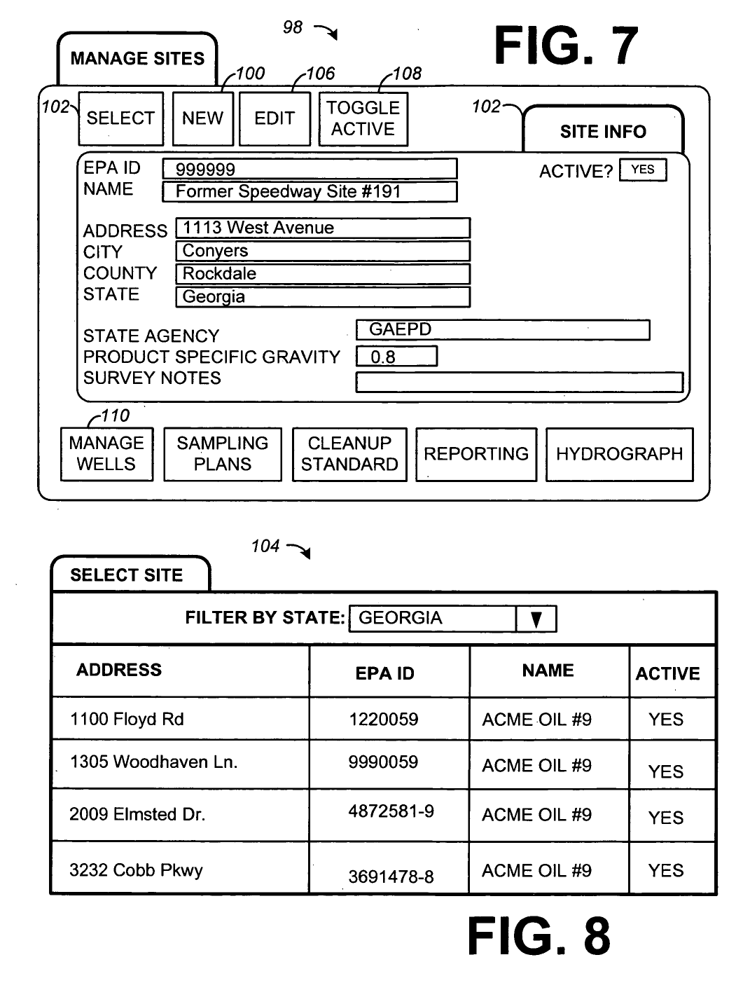

Initially, site and target information (e.g., site information 72 and well information 76 of FIG. 5) should be entered into the database in the base-station system 20. Accordingly, the manage sites button 96 may be pressed in order to invoke the manage sites interface 98 (FIG. 7), which is used to add or edit the site and target information in the database.

Looking to FIG. 7, an exemplary manage sites user interface 98 is depicted, which as displayed on base-station system 20 after invoking the manage sites button 96 in the top-level interface 88. To enter a new site, the user selects NEW button 100 to activate the site information area 102 of the interface. Once the site information area 102 is displayed, the user may input the appropriate site information such as the U.S. Environmental Protection Agency ID (EPA ID), name, address, city, county, state, state agency, the product specific gravity, and any survey notes. Each site may include a unique ID (e.g. the EPA ID) for unique identification.

A user may click SELECT button 102 to invoke the select site interface 104, depicted in FIG. 8, to view a list of known sites for editing. Select site interface 104 may also be used to browse information associated with the site such as, but not limited to, the wells associated with the site, sampling information, and purging information. Once a site has been selected from the site list in FIG. 8, the manage sites interface of FIG. 7 is populated with the site information. Accordingly, the site information can be edited using the EDIT button 106. Additionally, a particular site's status can be changed to ACTIVE or INACTIVE by choosing the TOGGLE ACTIVE button 108.

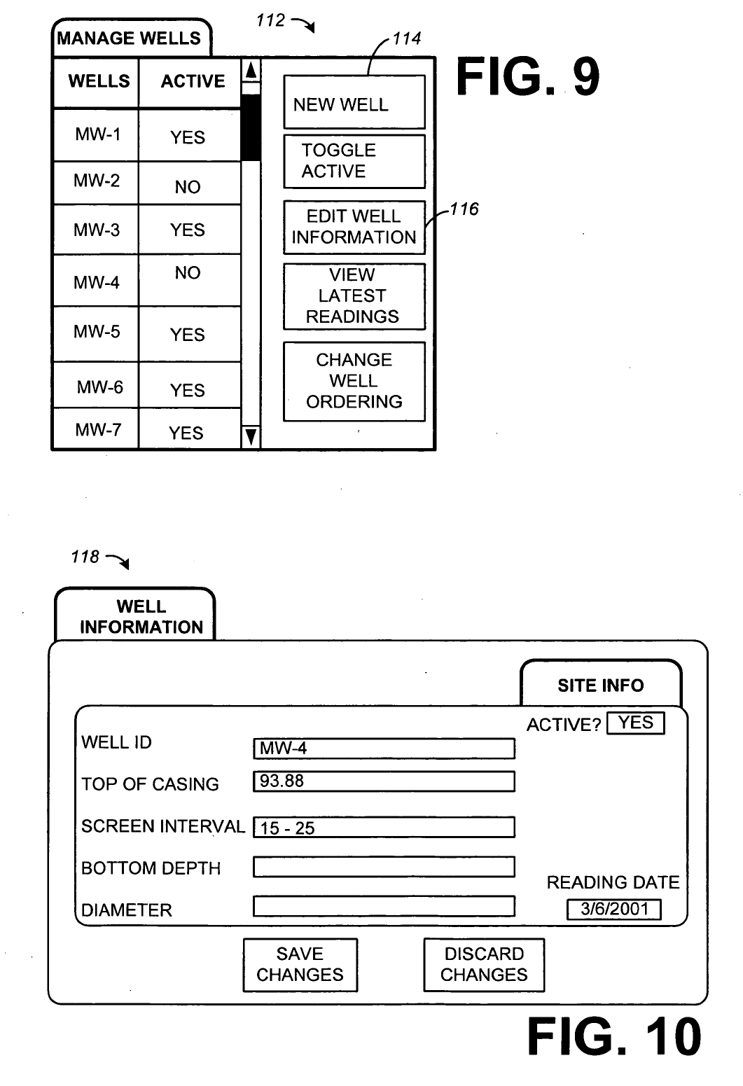

Once a site has been selected, the MANAGE WELLS button 110 may be selected to open manage wells interface 112, as depicted in FIG. 9. Manage wells interface 112 may display a list of wells for the respective site. Through manage wells interface 112, the user may add new wells to the site, edit existing well information, edit the latest well readings, change the ordering of the wells, or change the status of a well to inactive.

An inactive well is, for example, a well that has been abandoned or destroyed. Because these wells are no longer be available to be gauged or sampled, the base-station computing system 20 may be configured not to transfer information related to these wells to the portable computing system 28.

A new well may be added, or an existing well edited by selecting either the NEW WELL button 114, or the EDIT WELL INFORMATION button 116, respectively. The selection of either the NEW WELL button 114 or EDIT button 116, opens the well information interface 118 depicted in FIG. 10. Well information values, which may include, for example, the Well ID, Top of Casing, Screen Interval, Bottom Depth and Diameter may be entered or modified through the well information interface 118. The well information values generally relate to the construction of the well. Therefore, well information values do not generally change over time, except after periodic resurveying or other similar periodic updates, for example.

Looking back to the top-level interface of FIG. 6, an interface for adding and managing sampling methods may be invoked from sampling methods button 97. For example, a sampling method interface (not depicted) may enable the user to enter the name of a sampling method and specify the container type, preservative, size, count and hold time. Additionally, the analytes (e.g. “1,2,4-Trimethylbenzene,” “Acenaphthene,” “Diesel Range Organics,” etc.) that can be tested using the sampling method may be selected. A defined sampling method may then be assigned to a number of wells for a technician to follow during the completion of a work order.

Once a site and its associated well information is entered and stored in the base-station database, a work order for the well may be generated. A work order is generated by identifying a well to be inspected at a site, defining an inspection plan, and assigning the work order to a designated portable computing system. In one embodiment, the designated portable computing system may be assigned to a specific technician. Accordingly, from the perspective of a user who assigns the work orders, a work-order may be viewed as being assigned to a technician. In one embodiment, to assign a work order to a portable computing system, a user of base-station system 20 selects the WORK ORDERS button 120 on the top-level interface 88 of the desktop application module 59 (FIG. 6).

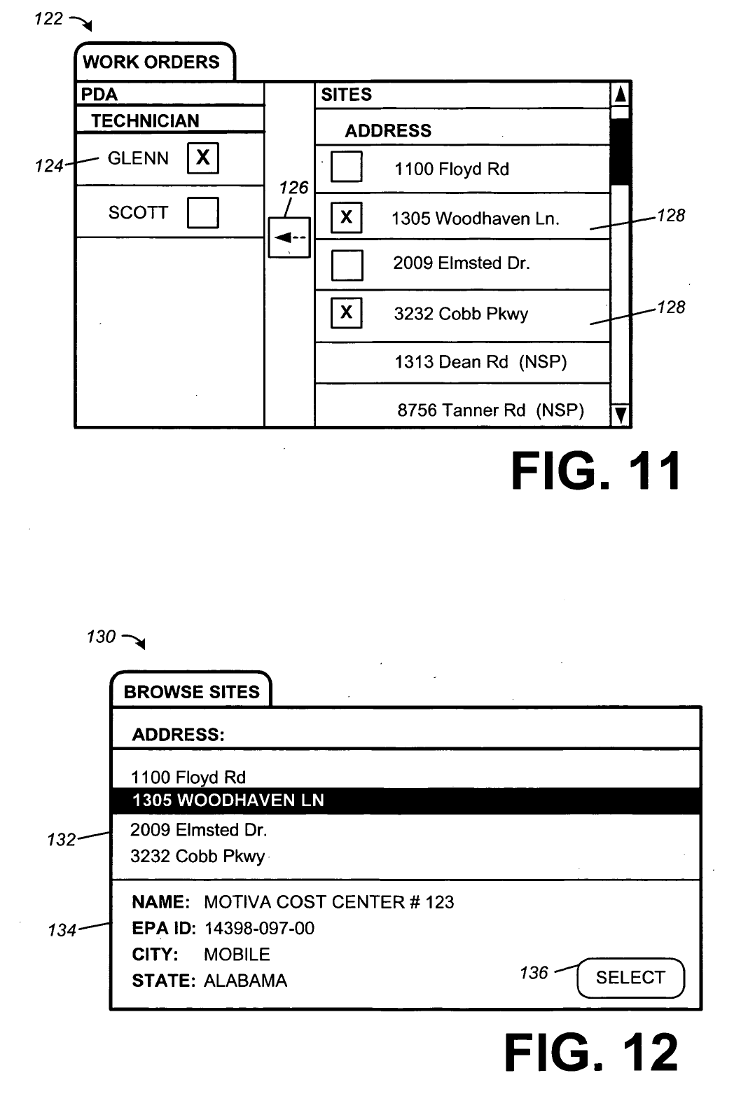

Once the WORK ORDERS button 120 is selected, a WORK ORDER interface 122, depicted in FIG. 11, may be displayed. The user may then select any number of sites 128 from the list on the right to be assigned to a portable electronic device (which is represented by the technicians name in a list on the left). Accordingly, a technician's user name 124 may be selected from a list on the left, and the arrow 126 is selected to assign the selected site address, or addresses, to the technician's user name 124. Because inspection plans, which may include sampling plans, may be predefined for a particular target, this assignment effectively generates the work order, which acts as a request for the technician to test the groundwater at the site according to the inspection plan defined by the work order.

In one embodiment, a technician is assigned a portable computing system 28, and this portable computing system 28 is associated with the technician's user name. However, in some embodiments, the technician's “name” may simply correspond to a pool of portable electronic devices which are, for example, assigned each morning to a number of technicians. In this case, the user name. 124 may read as “PDA #1” or “PDA #2”, and Glenn may be physically assigned PDA #1, for example. In either case, the technician synchronizes the associated portable computing system 28 with the base-station system 20, thereby transferring the appropriate work orders (here represented by the selected sites) to the portable computing system 28 associated with the technician. Once a work order is transferred to the technician's portable computing system 28, the technician follows the work order to perform the inspection of the respective targets.

Now that operation of using the base station computing device 20 to generate work orders has been described, attention is now directed to the functionality of executable modules which may be executed on the portable computing system 28 for completing the inspection activities defined by the work order. These modules may, for example, be included within field data collection module 56, and may be configured to display a number of interactive interfaces to assist the technician complete the assigned work orders.

In the present embodiment, the top level interface on portable computing system 28 is the browse sites interface 130, as depicted in FIG. 12. Browse sites interface 130 of FIG. 12 includes a site pane 132 and information pane 134. Site pane 132 displays the addresses of sites related to any work orders that have been transferred onto portable computing system 20 after synchronization with the base-station system 20. As described above, each of these sites represents at least one underlying work order with an inspection plan to be followed.

In the embodiment of FIG. 12, the technician has highlighted the “1305 WOODHAVEN LN” site, and a subset of information about this site is displayed in information pane 134. This information may be customized, but here, fields representing the name, EPA ID, City, and State are depicted. Accordingly, the values of the information associated with the site address of “1305 WOODHAVEN LN” are displayed in the appropriate fields in information pane 134.

In addition to displaying summary information about each of the sites, browse sites interface 130 may also be used as an entry point to: begin entering data for a particular work order inspection plan, view the wells (and associated information) for a particular site, or delete field measurements for a selected site.

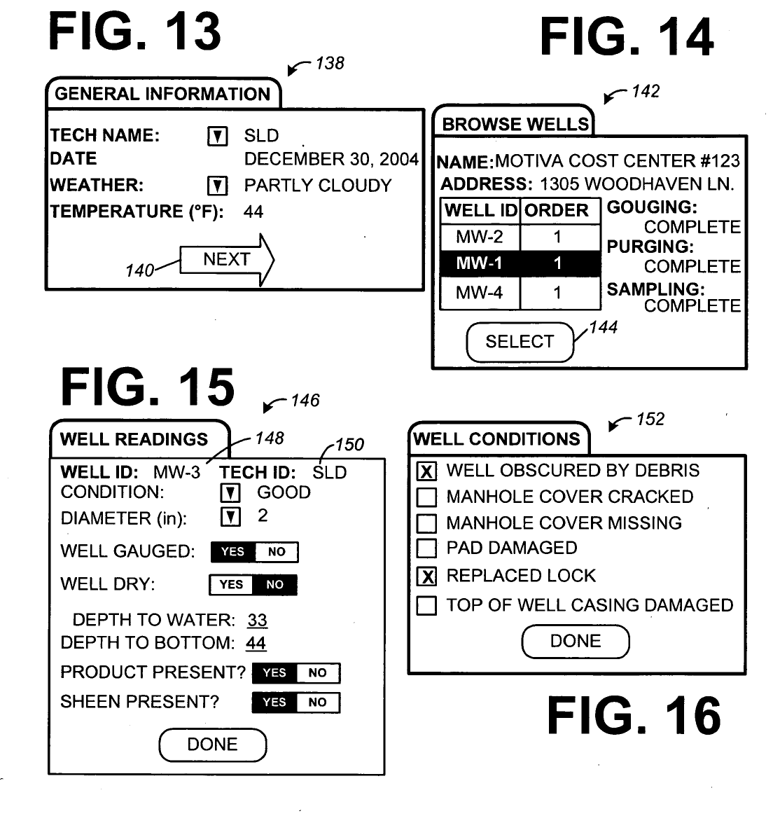

To begin following an inspection plan within a particular work order, the associated site is highlighted and the ‘Select’ button 136 is pressed. As depicted in FIG. 13, a general information interface 138, may be displayed for collecting the site information. General information interface 138, for example, may include the technician's name or identification, the date, the weather at the site, and the temperature.

In some embodiments, collection fields such as the date and technician name may be configured to be automatically populated. For example, the date may be populated based on the current date stored and maintained by the portable computing system 28. Once all relevant fields have been input into general information interface 138, the user may select the next arrow 140 to view the browse wells interface 142, as depicted in FIG. 14.

Browse wells interface 142 is used to select a particular well at a given site for taking and recording field measurements. For example, here, well MW-1 has been highlighted, and the associated testing status summary for this work order is listed on the right side of browse wells interface 142. For example, in the present embodiment, the testing status summary lists whether the gouging, purging, or sampling tests are COMPLETE, INCOMPLETE, or IN PROCESS.

After highlighting a well listed in browse wells interface 142, select button 144 is used to bring up the well readings interface 146, depicted in FIG. 15, which is used to enter gauging, purging and sampling information.

Well readings interface 146 interface may be configured to automatically populate the well ID 148 field and the Tech ID field 150 with the appropriate values. Further, the bottom depth and diameter may also be populated if the values were previously downloaded to the portable computing system 28. However, the technician is responsible for entering any target inspection information determined by observations or tests run while on site. For example, the Condition (e.g. GOOD, BAD, DAMAGED), Diameter, whether the Well was Gauged (Yes or No), Depth to Water, and the Depth to Bottom. To enter the data, the respective fields for each of the observations or tests are filled into the form, such as by tapping on a yes/no toggle box, making selections from popup lists and entering the appropriate depth information.

Well readings interface 146 may also have a field for designating that the well is destroyed or not found. If these fields are designated, any data recorded may be deleted or otherwise marked as invalid. Similarly, if “well gauged” indicates “NO,” the interface may be configured to disable the ability to enter data related to purging and sampling and mark any previously entered data as invalid (since a well cannot be purged or sampled without being gauged).

If a well condition of BAD or DAMAGED is selected, the module may be configured to display a well conditions interface 152 (FIG. 16) for entering a description of the deficiencies. For example, looking to FIG. 16, a technician has indicated that the well has been obscured by debris and that a lock was replaced. Other embodiments may include the capability to record custom well condition comments.

Well readings interface 1.46 may also include a number of other collection fields depending on the desired target inspection information to be collected. For example, the interface may include a “Well Sampled” field (e.g. with YES, NO, and PARTIAL values), a field to enter an “actual purge volume,” purging data (pH, temperature, conductivity, redox, and DO), sampling data fields (e.g., the sampling fields data may include, but are not limited to: a list of sample methods, the container type, container size, number of containers, hold time, date and time of the sample, and an area for entering freeform comments. In some embodiments, purging and sampling data may be recorded within their own interfaces. Further, in some embodiments, accessories and testing equipment may be configured to transfer information to the computing system 28 automatically, rather than through manual entry by the technician.

The target inspection information entered into the collection fields is stored on the personal computing device. For example, the data may be stored within a database, and the database may associate the values with the well, site, and/or work order.

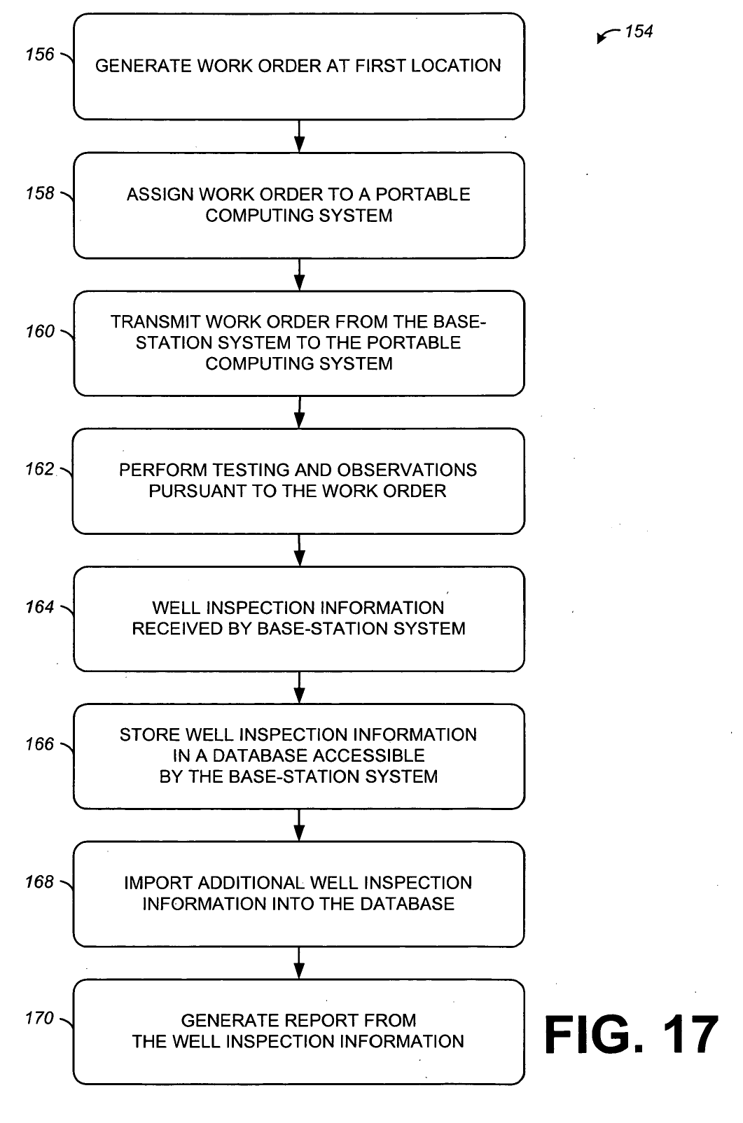

FIG. 17 depicts a flow diagram depicting the steps for an exemplary method 154 of groundwater monitoring and reporting using the proposed monitoring and reporting systems. First, at step 156, once site, target (e.g. well), and sampling information has been entered into base-station system 20, a work order may be generated at a first location. The work order may identify a groundwater well to be inspected at a site located remote from the first location, and defines an inspection plan for collecting well inspection information. At step 158, the work order is assigned to a portable computing system. At step 160, the work order may be transmitted from a base-station system to the portable computing system at a time when the portable computing system is located at the first location.

At step 162, testing and observations are performed in the field by the technician pursuant to the assigned work order. The results of the tests and the observations are recorded and stored within the personal computing system 28.

At step 164, well inspection information collected pursuant to the inspection plan is received by base-station 20 from the portable computing system at a time when the portable computing system is located at the first location. For example, this transfer of target inspection information may be performed during a synchronization operation. During this synchronization, the measurements and observations recorded by the technician are transferred from the portable computing system 28 to the base-station system 20. Additionally, in some embodiments, any new work orders assigned to that portable computing system may also be transferred to portable computing system 28.

At step 166, the collected well inspection information is stored in a database accessible by the base-station system. At step 168, additional well inspection information may be imported from a secondary information source into the database. Finally, at step 170, a report derived from at least one of the collected well inspection information or the additional well inspection information stored in the database may be generated. These reports may provide a summary of the results over a period of time. One report may depict all of the measurement results for each well at a particular site on a particular day, for example. These results may be further be configured to depict data visually (e.g. as charts and graphs).

Systems and methods for monitoring and reporting have been described. One potential advantage of the systems and methods (over traditional manual recording and entry methods, for example), include the reduction of typographical, handwriting and spelling mistakes that can occur when transcribing handwritten data (e.g. from paper) into a base-station computer. The systems and methods may ensure more consistent and complete data by guiding the technician through the field data collection process using, in many cases, a predefined subset of acceptable values.

It should be emphasized that many variations and modifications may be made to the above-described embodiments. All such modifications and variations are intended to be included herein within the scope of this disclosure and protected by the following claims.

What is claimed is:

1. A method for monitoring a groundwater well comprising:
generating a work order at a first location, the work order:
identifying a groundwater well to be inspected at a site located remote from the first location; and
defining an inspection plan for collecting well inspection information;
assigning the work order to a portable computing system;
transmitting the work order from a base-station system at the first location to the portable computing system at a time when the portable computing system is located at the first location;
receiving well inspection information collected pursuant to the inspection plan from the portable computing system at a time when the portable computing system is located at the first location;
storing the collected well inspection information in a database accessible by the base-station system;
importing additional well inspection information from a secondary information source into the database; and
generating a report, a portion of the report derived from at least one of the collected well inspection information or the additional well inspection information stored in the database.

2. A method comprising:
generating a work order at a first location, the work order:
identifying a target to be inspected at a site located remote from the first location; and
defining an inspection plan for collecting target inspection information;
assigning the work order to a portable computing system; and
transmitting the work order from a base-.station system at the first location to the portable computing system.

3. The method of claim 2, further including:
receiving target inspection information collected pursuant to a preassigned work order from the portable computing system.

4. The method of claim 3, wherein the steps of transmitting the work order and receiving the target inspection information are performed during a synchronization operation.

5. The method of claim 2, further including:
receiving target inspection information collected pursuant to the inspection plan from the portable computing system.

6. The method of claim 5, wherein the steps of receiving collected target inspection information and transmitting the work order are performed at a time when the portable computing system is located at the first location.

7. The method of claim 5, further including:
storing the collected target inspection information in a database accessible by the base-station system.

8. The method of claim 7, further including:
generating a report, a portion of the report derived from the target inspection information stored in the database.

9. The method of claim 7, further including:
importing additional target inspection information from a secondary information source into the database.

10. The method of claim 7, wherein the step of storing the collected target inspection information includes storing at least one of: data representing the weather conditions at a site of the target, data representing target measurements, and data representing the tests conducted at the target.

11. The method of claim 2, wherein the step of generating the work order includes retrieving predetermined target information from the database.

12. The method of claim 2, wherein the target inspection information includes at least one of: the weather conditions at the site, the target conditions, physical observations of the target, identification of samples removed from the target, the target tests performed, the results of the target tests.

13. A method comprising:
receiving a work order on a portable computing system, the work order:
identifying a target to be inspected at a remote site; and
defining an inspection plan for collecting target inspection information;
collecting target inspection information at the remote site with the portable computing system pursuant to the inspection plan; and
transmitting the collected target inspection information from the portable computing system to a base-station system.

14. The method of claim 13, wherein the steps of receiving the work order and transmitting the collected target inspection information are performed during a synchronization operation.

15. The method of claim 13, displaying at least one interactive interface for collecting the target inspection information.

16. The method of claim 13, wherein the step of collecting target inspection information includes collecting at least one of: the weather conditions at the site, the target conditions, physical observations of the target, identification of samples associated with the target, identification of the performed target tests, and the results of the performed target tests.

17. The method of claim 13, wherein the step of collecting target inspection information includes receiving data from any one of: a bar code scanner, a camera, a GPS unit, and a voice recorder.

18. The method of claim 13, wherein the steps of receiving the work order and transmitting the target inspection information are performed at a time when the portable computing system is within close proximity of the base-station system.

19. The method of claim 13, further including:
storing the collected target inspection information within at least one record in a database accessible by the portable computing system; and
transferring the at least one record to the base-station system.

20. A computer-readable medium having a computer program stored thereon, the computer-readable medium comprising logic configured to:
generate a work order at a first location, the work order:
identifying a target to be inspected at a site located remote from the first location; and
defining an inspection plan for collecting target inspection information;
assign the work order to a portable computing system; and
transmit the work order from a base-station system at the first location to the portable computing system.

21. The computer-readable medium of claim 20, further including logic configured to:
receive target inspection information collected pursuant to the inspection plan from the portable computing system.

22. The computer-readable medium of claim 21, wherein the logic configured to receive target inspection information and transmit the work order are configured for use at a time when the portable computing system is located at the first location.

23. The computer-readable medium of claim 21, further including logic configured to:
store the collected target inspection information in a database accessible by the base-station system.

24. The computer-readable medium of claim 23, further including logic configured to:
generate a report, a portion of the report derived from the target inspection information stored in the database.

25. The computer-readable medium of claim 23, further including logic configured to:
import additional target inspection information from a secondary information source into the database.

26. The computer-readable medium of claim 20, wherein the logic configured to generate the work order includes logic configured to retrieve predetermined target information from the database.

27. A computer-readable medium having a computer program stored thereon, the computer-readable medium comprising logic configured to:
receive a work order on a portable computing system, the work order:
identifying a target to be inspected at a remote site; and
defining an inspection plan for collecting target inspection information;
collect target inspection information at the remote site with the portable computing system pursuant to the inspection plan; and
transmit the collected target inspection information from the portable computing system to a base-station system.

28. The computer-readable medium of claim 27, further comprising logic configured to:
display at least one interactive interface for collecting the target inspection information.

29. The computer-readable medium of claim 27, further comprising logic configured to collect target inspection information from any one of: a bar code scanner, a camera, a GPS unit, or a voice recorder.

30. The computer-readable medium of claim 1, wherein the logic configured to receive the work order and the logic configured transmit the collected target inspection information are configured to be executed only at a time when the portable computing system is within close proximity of the base-station system.

31. The computer-readable medium of claim 1, further including logic configured to:
store the collected target inspection information within at least one record in a database accessible by the portable computing system; and
transfer the at least one record to the base-station system.
